(19) United States
(12) Patent Application Publication
(10) Pub. No.: US 2014/0121024 A1
(43) Pub. Date: May 1, 2014

(54) COLLABORATION SYSTEM AND METHOD THEREFOR

(71) Applicant: Zhaohui Xing, Calgary (CA)

(72) Inventor: Zhaohui Xing, Calgary (CA)

(21) Appl. No.: 13/666,952

(22) Filed: Nov. 1, 2012

(51) Int. Cl. H04L 29/08; A63F 13/12

(52) U.S. Cl. CPC H04L 67/10; A63F 13/12
USPC 463/42; 709/204

(57) ABSTRACT

A system and method for facilitating user collaboration in real time are disclosed. The system comprises a network and a message queue service in the network that creates one or more message queues shared by multiple user computing devices for transmitting collaboration data between users.

### FIELD OF THE INVENTION

The subject application relates generally to a system and method for facilitating user collaboration, and in particular, a system and method for facilitating user collaboration in real time.

### BACKGROUND OF THE INVENTION

Collaboration systems, including online gaming systems, have been widely used. Many collaboration systems, including online gaming systems, requires real-time communication of a large amount of data among multiple participants. For example, in today's multiple-player interactive online gaming systems, data communication is implemented by using socket with TCP or UDP protocol. Although using socket with TCP or UDP protocol has the advantage of high performance and throughput, this method also has the disadvantages of high sophistication causing difficulty in design and implementation, difficult to deploy a game service system using this method, and high hardware and software cost in deploying and maintaining such a game service system.

It is therefore an object of the present invention to provide a novel system and method for facilitating user collaboration in real time.

### SUMMARY OF THE INVENTION

Accordingly, in one aspect there is provided a computerized method for managing collaboration of a plurality of computing devices over a network, said method comprising: associating at least one data queue with each of said a plurality of computing devices, wherein each of said at least one data queue is only allowed to be locked by the computing device associated therewith.

According to another aspect, the computerized method further comprises: receiving, from a first computing device, data to be shared with a second computing device; writing said data into a data queue associated with said second computing device; and retrieving, by said second computing device, said data from said data queue.

According to yet another aspect there is provided a computerized network system for managing user collaboration comprising: a network; at least two computing devices; and at least one server functionally coupled to said at least two computing devices via the network, and executing computer executable code to associate at least one data queue with each of at least two computing devices, wherein each of said at least one data queue is only allowed to be locked by the computing device associated therewith.

According to still another aspect, said at least one server of the computerized network system executes computer executable code to further receive, from a first computing device, data to be shared with a second computing device; and write said data into a data queue associated with said second computing device.

According to another aspect there is provided a non-transitory computer readable medium having computer executable code for managing a plurality of computing devices over a network, the computer executable code comprising: computer executable code for associating at least one data queue with each of said a plurality of computing devices, wherein each of said at least one data queue is only allowed to be locked by the computing device associated therewith.

According to yet another aspect, the non-transitory computer readable medium further comprises: computer executable code for receiving, from a first computing device, data to be shared with a second computing device; and computer executable code for writing said data into a data queue associated with said second computing device.

According to still another aspect, at least a portion of said executable code for associating at least one data queue with each of said a plurality of computing devices is for commanding a data queue managing system to create a data queue.

Accordingly, there may be provided another non-transitory computer readable medium comprising computer executable code for generating data to be shared with one or more other computing devices, sending said data to the data queue management system for writing it into a data queue, and computer executable code for retrieving data from a data queue.

According to another aspect there is provided a computerized method for managing collaboration of a plurality of computing devices over a network, said method comprising: associating at least one data queue with said a plurality of computing devices; receiving, from a first computing device, data to be shared with a second computing device; encoding said data to text form; and writing the encoded data into a data queue. According to yet another aspect, the computerized method of claim 13 further comprises: retrieving, by said second computing device, said data from said data queue; and decoding, by said second computing device, the retrieved data to binary form.

The collaboration mentioned above may be in the form of a multi-user game, and the data queue may be a Message Queue (MQ). The MQ may be managed by a commercially available MQ management system or MQ service. Alternatively, MQ may be managed by a MQ management system specifically designed for a particular collaboration system such as an online gaming system.

Although MQ technologies are mainly used in instant messenger applications, data transition or exchange applications, message or event notification systems, and text-based message sharing services such as online game's LeaderBoard, Achievement, game player comment posting, where players may post game related information therein and share it with other players, in this embodiment, the MQ service is used for transmitting binary collaboration data, e.g., gaming data, among users. With a small latency (e.g., about 20 to 30 milliseconds for Amazon AWS Simple Queue Service (SQS)) that meets the real-time communication requirement of typical collaboration systems such as most online multi-player gaming systems, the method of using MQ for transmitting collaboration data as described herein provides a comparable performance as traditional socket-based technologies. However, since an online gaming system using MQ for transmitting collaboration data may be deployed on many commercially available MQ services, such an online gaming system also provides the advantages of simple design and implementation that does not require any specific game server, high scalability and low deployment and operation cost.

### BRIEF DESCRIPTION OF THE DRAWINGS

Embodiments will now be described more fully with reference to the accompanying drawings in which:

FIG. 1 shows a schematic view of a collaboration system;

FIG. 2 shows a schematic view of a collaboration system according to one embodiment;

FIG. 3 shows an example of a collaboration system according to another embodiment;

FIG. 4 is a flowchart showing steps performed by a user computing device for playing a multi-user game;

FIG. 5 shows a schematic view of a collaboration system 500 according to an alternative embodiment; and

FIG. 6 shows an example of a collaboration system according to yet another embodiment.

### DETAILED DESCRIPTION OF THE EMBODIMENTS

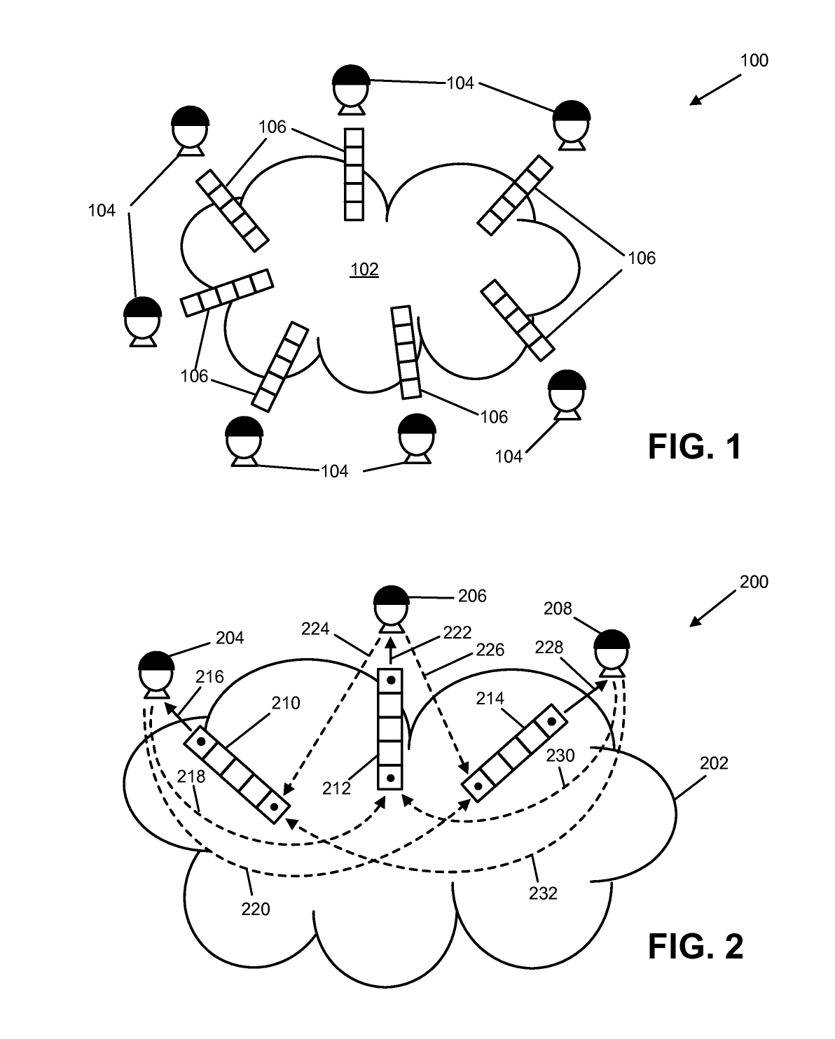

FIG. 1 shows a schematic view of a collaboration system 100, for example, an online gaming system for managing collaboration of two or more user computing devices. The collaboration system 100 comprises a network 102, such as Internet, a Location Area Network (LAN), an intranet of an organization or a WiFi wireless network and/or a mobile phone wireless network, e.g., a 3G or 4G wireless network. A plurality of user computing devices 104, each running a collaboration software program, e.g., a online multi-user game program, access the network 102 via wired or wireless connections, and collaborate with each other.

Here, user computing devices may be desktop computers and/or portable computing devices such as tablets, smartphones, PDAs, game consoles, and notebook computers. The user computing device 104 may comprise a screen, a processing unit, violate and/or non-violate memory (e.g., a hard disk drive, RAM, ROM, EEPROM, CD-ROM, DVD, flash memory, etc.) and a system bus coupling the various computer components to the processing unit. The screen may be a touch-sensitive display capable of detecting pointer (e.g., finger or stylus) contacts applied thereon or alternatively a screen without touch sensing capability. The computing device may also comprise other components such as a camera, HDMI port, Ethernet interface, WiFi interface, Bluetooth interface, universal serial bus (USB) port, FireWire port, etc., depending on the implementation.

One or more servers (not shown) in the network 102 (collectively called “internet cloud” or “cloud”) provides message queue (MQ) service to allow users thereof to share messages with each other via one or more message queues 106. The MQ service may be provided by a commercially available MQ management system (or so called MQ service) such as Amazon AWS Simple Queue Service (SQS), RabbitMQ or the like, or an MQ management system or service particularly designed for the collaboration system using MQ technologies such as Microsoft Message Queuing technology, Java Message Service technology, or the like, depending on the implementation.

As is known, a message queue is a plurality of data packets arranged into a queue transmitted among a plurality of users. Each data packet comprises the information of the sender (the user computing device that sends the message data packet), the information of the receiver (the user computing device that is to receive the message data packet) and message data. The message data may be encrypted so that only the intended receiving computing device may decrypt it.

A user computing device may send a message to another user computing device by attaching one or more data packet to the end of the MQ. A user computing device also periodically polls the MQ and checks if any data packet therein comprises sender information matching the identity of the user computing device (e.g., the IP address of the user computing device, or game player identification generated by the collaboration system). If a data packet therein comprises sender information matching the identity of the user computing device, the user computing device then locks the MQ for a predefined period of time to prevent other user computing devices from accessing the MQ, and retrieves the data packet therefrom. The MQ is unlocked to allow other user computing device to access after the locking time has passed. If no data packet therein comprises sender information matching the identity of the user computing device, the user computing device ignores the MQ.

Various embodiments are now described in more detail. FIG. 2 shows a schematic view of a collaboration system 200 according to one embodiment. The collaboration system comprises a network or cloud 202 proving MQ service to user computing devices 204, 206 and 208. The MQ service creates a MQ 210, 212 and 214 for each user computing device 204, 206 and 208, respectively, and associates each MQ with the respective user. In this embodiment, each user computing device 204, 206 and 208 may write into (i.e., attach data packets to) the MQ associated with another user computing device to send the gaming data thereto. However, a MQ is only allowed to be queried by the user computing device associated therewith to retrieve data packets therefrom. For example, user computing device 204 may write into MQs 212 and 214 associated with user computing devices 206 and 208, as indicated by the broken-line arrow 218 and 220, respectively; user computing device 206 may write into MQs 210 and 214 associated with user computing devices 204 and 208, as indicated by the broken-line arrow 224 and 226, respectively; and user computing device 208 may write into MQs 210 and 212 associated with user computing devices 204 and 206, as indicated by the broken-line arrow 230 and 232, respectively. However, user computing device 204 is only allowed to query and retrieve data packets from MQ 210 associated therewith, as indicated by the solid-line arrow 216; user computing device 206 is only allowed to query and retrieve data packets from MQ 212 associated therewith, as indicated by the solid-line arrow 222; and user computing device 208 is only allowed to query and retrieve data packets from MQ 214 associated therewith, as indicated by the solid-line arrow 228.

Since an MQ is only allowed to be queried and locked by the user computing device associated therewith, the collaboration system 200 therefore avoids the lockout issue in which a user computing device may fail to query an MQ because the MQ is locked and queried by another user computing device. In this embodiment, the message data in each data packet comprises gaming data, which is unencrypted since only the intended receiver, i.e., the user computing device associated with the MQ, is allowed to access the MQ.

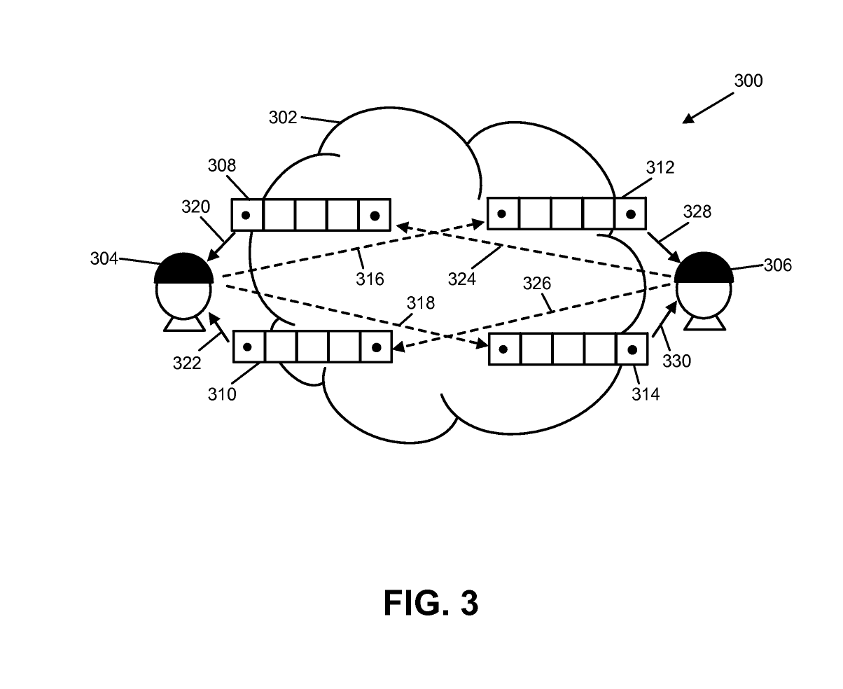

In a related embodiment, the MQ service in the network may create multiple MQs for a user. FIG. 3 shows an example of a collaboration system 300 according to this embodiment. In this example, two user computing devices 304 and 306 are connected to the network 302. The MQ service in the network 302 creates two MQs for, and associates the created MQs with, each user 304, 306, including an invitation MQ for transmitting game invitation, and a game data MQ for transmitting game data. For example, the MQ service creates an invitation MQ 308 and a game data MQ 310 for user computing device 304. Similarly, the MQ service creates an invitation MQ 312 and a game data MQ 314 for user computing device 306. As described above, user computing device 304 is allowed to write into MQs 312 and 314 associated with user computing device 306, as indicated by broken-line arrows 316 and 318, respectively. However, user computing device 304 is only allowed to query MQs 308 and 310 associated therewith, as indicated by the solid-line arrows 320 and 322, respectively. Similarly, user computing device 306 is allowed to write into MQs 308 and 310 associated with user computing device 304, as indicated by broken-line arrows 324 and 326, respectively. However, user computing device 306 is only allowed to query MQs 312 and 314 associated therewith, as indicated by the solid-line arrows 328 and 330, respectively.

When a user, e.g., the user of computing device 304, wants to play game with the user of computing device 306, user computing device 304 sends an invitation message to user computing device 306 via MQ 312. User computing device 306 periodically checks the MQs associated therewith. Once user computing device 306 receives the invitation message from the MQ 312, it presents the invitation message to the user. If the user decides to reject the game invitation sent from the user of computing device 304, the user computing device 306 then sends a rejection message to user computing device 304 by writing the rejection message into MQ 308. The game invitation is then failed.

If the user of computing device 306 decides to accept the game invitation sent from the user of computing device 304, the user computing device 306 then sends an acceptation message to user computing device 304 by writing the acceptation message into MQ 308. After the user computing device 304 retrieves the acceptation message from MQ 308, a game is then started between user computing devices 304 and 306.

During game playing, user computing device 304 sends game data generated therein to user computing device 306 by writing game data into MQ 314. User computing device 306 periodically checks MQ 314, and retrieves game data therefrom. Similarly, user computing device 306 sends game data generated therein to user computing device 304 by writing game data into MQ 310. User computing device 304 periodically checks MQ 310, and retrieves game data therefrom. Collaboration between user computing devices 304 and 306 is then established.

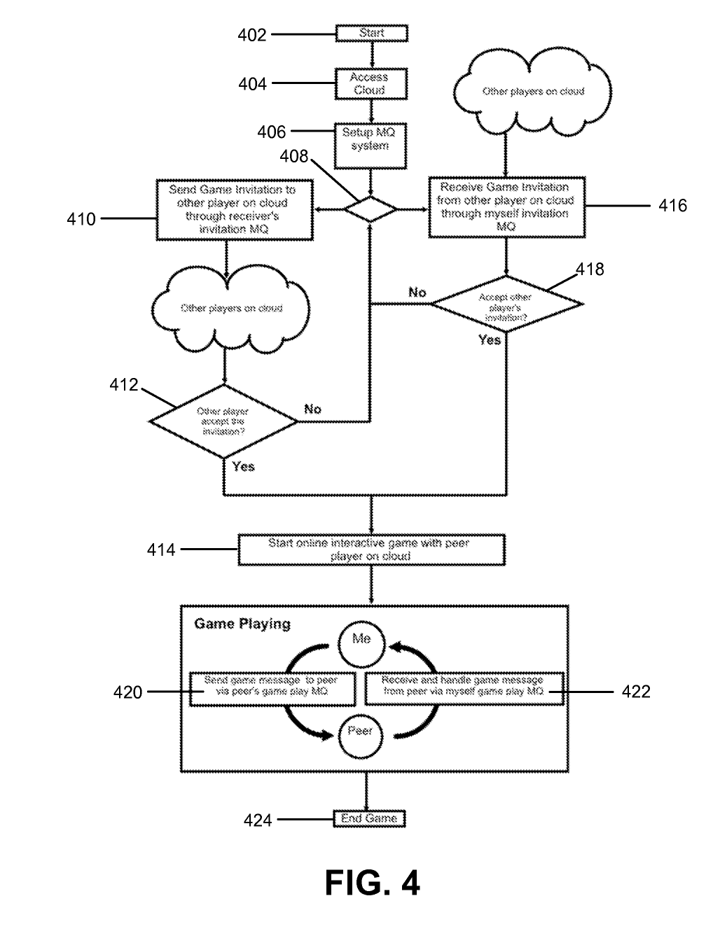

FIG. 4 is a flowchart showing steps performed by a user computing device (denoted as “Me”) for playing a multi-user game. A piece of C++ style pseudo code is also listed in the Appendix.

The process starts when the user computing device “Me” connects to the cloud 302 and executes the multi-user game program (step 402). After the user computing device “Me” connects to the cloud 302 (step 404), the MQ service in the cloud 302 creates two MQs for the user computing device “Me” (step 406). As described above, the MQ service in the cloud 302 also creates two MQs for other user computing devices connecting to the cloud 302. At step 408, the user computing device “Me” makes a branching decision based on whether the user thereof decides to invite other users to play a game, and whether it receives any game invitation from other user computing devices. If the user of the computing device “Me” decides to invite one or more other users to play a game, the user computing device “Me” sends game invitation to respective user computing devices by writing game invitation message to the game invitation MQs associated therewith (step 410). As described above, computing devices that receive the game invitation replies with a rejection or acceptation message by writing the message into the game invitation MQ associated with the user computing device “Me”. The user computing device “Me” receives the reply message, and checks if any invited computing devices have accepted game invitation (step 412). If no invited computing device accepts the game invitation, the process goes back to step 408 for making another branching decision.

If at step 412, one or more invited user computing device accept the game invitation, the process goes to step 414 to start the online multi-user interactive game with the users who have accepted the game invitation (so called “peer players”).

If at step 408, the user computing device “Me” receives a game invitation, the user computing device “Me” retrieves the game invitation (step 416), and asks the user to decide whether the received game invitation shall be accepted (step 418). If the user decides to reject the invitation, the process goes back to step 408 to make another branching decision.

If at step 418, the user decides to accept the game invitation, the process goes to step 414 to start the online multi-user interactive game.

During game playing, the user computing device “Me” sends game data to other user computing devices by writing the game data into their game data MQs (step 420). Other user computing devices then retrieve game data from their game data MQs and process the received game data.

Similarly, other user computing devices may also send their game data to the user computing device “Me” by writing their game data into the game data MQ associated with the user computing device “Me”. The user computing device “Me” receives the game data from its game data MQ and processes it (step 422). Steps 420 and 422 are repeated until the game is terminated (step 424).

During collaboration, a data packet sent to a user computing device may be delayed due to network traffic jam or other reasons. The collaboration system solves this issue by including a timestamp in each data packet. If a user computing device detects, based on the timestamps in received data packets, that a data packet is received later than some data packets that was sent thereafter, the user computing device the drops the data packet and requests the sender to resend it. However, those skilled in the art will appreciate that, in some embodiments in which timing is less critical, delayed data packets may still be used.

In some embodiments, the MQ service, e.g., the Amazon AWS SQS, only allows text message to be written into MQs. In these embodiments, user computing devices encode the generally binary game data into text form by using an appropriate encoding algorithm, and write encoded game data into MQs. The receiving user computing device, after retrieving the encoded game data from the MQ, decode retrieved data to binary form.

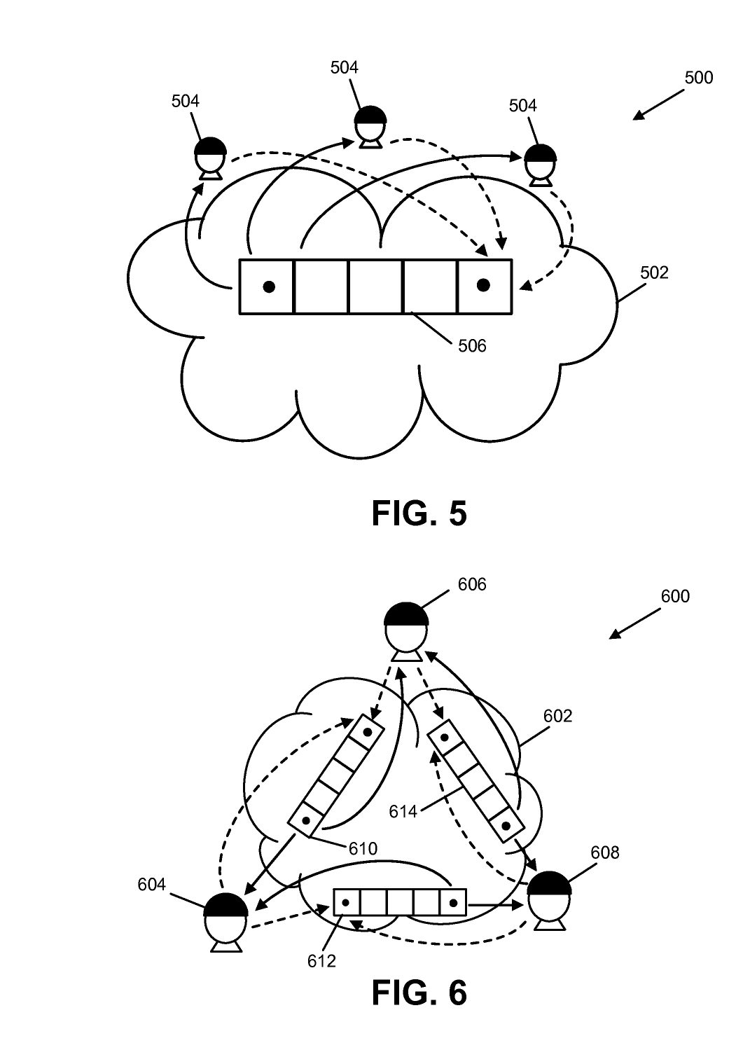

FIG. 5 shows a schematic view of a collaboration system 500 according to an alternative embodiment. In this embodiment, multiple user computing devices 504 connecting to the cloud 502 share the same MQ 506 provided by the MQ service in the cloud 502. Each user computing device may write collaboration data into the shared MQ 506, or retrieve from the MQ 506 collaboration data that is sent thereto (i.e., data packets having receiver information matching the identity of the user computing device). Since the MQ 506 is shared by multiple user computing devices, the collaboration data therein may be encrypted so that only the intended receiver may successfully retrieve it.

In another embodiment, the MQ service dynamically creates a MQ for a group of user computing devices that agree to collaborate (e.g., after a user computing device sending a collaboration request to some other user computing devices and after the request being accepted). All user computing devices associated with a MQ may write collaboration data into the MQ or retrieve collaboration data therefrom. Each user computing device may write collaboration data into the shared MQ, or retrieve from the MQ collaboration data that is sent thereto. Since each MQ is shared by multiple user computing devices, the collaboration data therein may be encrypted so that only the intended receiver may successfully retrieve it.

FIG. 6 shows an example of a collaboration system 600 according to this embodiment. In this example, user computing devices 604 and 606 agree to collaborate with each other, and the MQ service in the cloud 602 creates a MQ 610 for sharing between user computing devices 604 and 606. Similarly, the MQ service in the cloud 602 creates a MQ 612 for sharing between user computing devices 604 and 608 that agree to collaborate with each other, and creates a MQ 614 for sharing between user computing devices 606 and 608 that agree to collaborate with each other. User computing device 604 may write data into or retrieve data from MQs 610 and 612 associated therewith, user computing device 606 may write data into or retrieve data from MQs 610 and 614 associated therewith, and user computing device 608 may write data into or retrieve data from MQs 612 and 614 associated therewith,

Those skilled in the art will appreciate that the embodiments described above are for illustrative purposes only, and variations and modifications may be readily made without departing from the scope thereof as defined by the appended claims.

What is claimed is:

1. A computerized method for managing collaboration of a plurality of computing devices over a network, said method comprising:
associating at least one data queue with each of said a plurality of computing devices, wherein each of said at least one data queue is only allowed to be locked by the computing device associated therewith.

2. The method of claim 1 further comprising:
receiving, from a first computing device, data to be shared with a second computing device;
writing said data into a data queue associated with said second computing device; and
retrieving, by said second computing device, said data from said data queue.

3. The method of claim 2, wherein said data queue is a Message Queue.

4. The method of claim 3, wherein said collaboration is a multi-user gaming over said network.

5. A computerized network system for managing user collaboration comprising:
a network;
at least two computing devices; and
at least one server functionally coupled to said at least two computing devices via the network, and executing computer executable code to
associate at least one data queue with each of at least two computing devices, wherein each of said at least one data queue is only allowed to be locked by the computing device associated therewith.

6. The computerized network system of claim 5 wherein said at least one server executes computer executable code to further
receive, from a first computing device, data to be shared with a second computing device; and
write said data into a data queue associated with said second computing device.

7. The computerized network system of claim 6 wherein said data queue is a Message Queue.

8. The computerized network system of claim 6 wherein said user collaboration is playing a multi-user game via said network.

9. A non-transitory computer readable medium having computer executable code for managing a plurality of computing devices over a network, the computer executable code comprising:
computer executable code for associating at least one data queue with each of said a plurality of computing devices, wherein each of said at least one data queue is only allowed to be locked by the computing device associated therewith.

10. The non-transitory computer readable medium of claim 9 further comprising:
computer executable code for receiving, from a first computing device, data to be shared with a second computing device; and
computer executable code for writing said data into a data queue associated with said second computing device.

11. The non-transitory computer readable medium of claim 10 wherein at least a portion of said executable code for associating at least one data queue with each of said a plurality of computing devices is for commanding a data queue managing system to create a data queue.

12. The non-transitory computer readable medium of claim 11 wherein said data queue management system is a Message Queue system.

13. A computerized method for managing collaboration of a plurality of computing devices over a network, said method comprising:
associating at least one data queue with said a plurality of computing devices;
receiving, from a first computing device, data to be shared with a second computing device;
encoding said data to text form; and
writing the encoded data into a data queue.

14. The method of claim 13 further comprising:
retrieving, by said second computing device, said data from said data queue; and
decoding, by said second computing device, the retrieved data to binary form.

15. The method of claim 15, wherein said data queue is a Message Queue.

16. The method of claim 15, wherein said collaboration is a multi-user gaming over said network.
